(19) United States
(12) Patent Application Publication
(10) Pub. No.: US 2017/0182696 A1
(43) Pub. Date: Jun. 29, 2017

(54) PARTICLE FOAM DISTRIBUTED MANUFACTURING APPARATUS AND METHOD AND PARTICLE FOAM ARTICLES

(71) Applicant: LIFOAM INDUSTRIES, LLC, Hunt Valley, MD (US)

(72) Inventors: John CANTLIN, Pikesville, MD (US); Saumitra BHARGAVA, Clarksville, MD (US)

(73) Assignee: LIFOAM INDUSTRIES, LLC, Hunt Valley, MD (US)

(21) Appl. No.: 15/128,807

(22) PCT Filed: Mar. 24, 2015
(86) PCT No.: PCT/US2015/022211

§ 371 Date: Sep. 23, 2016

Related U.S. Application Data
(60) Provisional application No. 61/970,389, filed on Mar. 26, 2014.

(51) Int. Cl. B29C 47/00; B29B 7/42; B29B 9/06; B29C 47/08

(52) U.S. Cl. CPC B29C 47/0042; B29C 47/0011; B29C 47/0864; B29B 7/42; B29B 9/06; B29K 2105/0005

(57) ABSTRACT

A mobile platform including an extruder for melting and extruding materials for producing lightweight, compostable or biobased foams for various expandable materials. A mobile platform is described including a screw extruder for processing poly meric material, a housing with a longitudinal bore in which an extruder screw is coaxially fitted for rotation around an axis of the screw to advance the polymeric material through the bore by threads on the screw. A feed hopper, PLA hoist/feeder, standard EPS machine equipped with electric heating and related equipment are also provided on the mobile platform. Distributed manufacturing of low density protective packaging, insulation panels and thermal insulators is also described.

### CROSS-REFERENCE TO RELATED APPLICATIONS

The instant application is an International Application based on U.S. Provisional Application No. 61/970,389, filed Mar. 26, 2014, the disclosure of which is hereby expressly incorporated by reference herein in its entirety.

### TECHNICAL FIELD

The present invention relates to an extruder and particle molding apparatus especially for the foam extrusion of polymeric foams. In particular, the present invention discloses a mobile platform having an extruder for melting and extruding materials and molding apparatus for producing lightweight foams for various expandable materials.

### BACKGROUND

Polymeric foams include a plurality of voids, also called cells, in a polymer matrix. By replacing solid plastic with voids, polymeric foams use fewer raw materials than solid plastics for a given volume, and have attractive physical properties such as thermal insulating and energy absorption upon compression. Thus, by using polymeric forms instead of solid plastics, material costs and physical properties can be enhanced in many applications.

Given these considerations, the extrusion of foamed plastics has seen increasing importance. Various configurations have arisen for extruders suitable for use with foamed plastics, including single-screw extruders and twin-screw extruders, among others. Furthermore, the starting material basis for extrusion has become more diverse. Apart from the starting material, additives and blowing agents are also of importance. In the field of blowing agents, there are chemical blowing agents and physical blowing agents. These blowing agents can also result in good foaming results under difficult general conditions.

Extruded materials produced by an extruder can take many forms. For example, molded plastics such as household items can be molded from beads produced from an extruder. Expanded polystyrene (EPS), other expanded, modified styrene type materials, expanded polypropylene (EPP) and expanded thermoplastic urethane (ETPU) suitable for molding operations can also be produced by such an extrusion process.

The process of converting EPS resins into expanded polystyrene foam article requires three main stages: pre-expansion, maturation, and molding. Expandable pellets produced from polystyrene and a blowing agent are made, and then expanded in a pre-expander. The purpose of pre-expansion is to produce foam beads of the desired density for a specific application. Maturation allows the vacuum that was created within the cells of the foam beads during pre-expansion to reach equilibrium with the surrounding atmospheric pressure, and provides for the dissipation of excess residual blowing agent as well as moisture. The large bags that store pre-expanded bead also act as an accumulator enabling the production rate of the pre-expander to be coordinated with the production rates of multiple molding machines. For these reasons, pre-expansion into large storage bags is a necessary step in the EPS molding process.

Once the pre-expanded beads have matured, they are transferred to a molding machine containing one or more cavities that are shaped like the desired molded foam article(s). The purpose of molding is to fuse the foam particles together into a single foam part. Molding of EPS may follow a simple sequence: first, fill the mold cavity with pre-expanded beads; heat the mold to fuse and expand the pre-expanded beads; cool the molded foam article within the mold cavity; and eject the finished part from the mold cavity.

There is an increasing demand for many plastic products used in packaging to be biodegradable, for example protective packaging for small appliances. Thus, rather than using EPS, a novel approach to creating biodegradable products is to use polylactic acid (PLA) with one or more blowing agents to create a degradable composition.

Typically for molding operations, commercially prepared EPS or PLA pellets are delivered to a manufacturer before those pellets are pre-expanded or extruded (in cases where the expansion occurs in an extruder rather than a pre-expander). In either case, the volume after delivery of the resin is materially expanded. The density of pre-expanded EPS granules is about 33 lbs/ft³ (pounds per cubic foot), and that of expanded EPS beads lies in the range of 1 to 5 lbs/ft³; depending on the process, a 5 to 40 times reduction in density may be achieved, Likewise, PLA pellets undergo a similar density reduction during the expansion in an extrusion process.

More particularly, for the manufacture of foam articles, bags of the relatively higher density pellets may be provided to a foam article molder, typically in large bags. Those bags of commercially prepared pellets are manipulated by cranes, positioning them over a hopper that may drop the pre-expanded pellets onto a conveyor, which in turn directs them to an expander. The expander then significantly increases the volume of each of the pellets, producing expanded beads having a significant reduction in density. Those expanded beads are then ultimately directed to molding machines for molding articles from the expanded beads. For supplying those molding machines, the now expanded beads are directed to enormous storage bags that may be positioned directly near the molding machines, and transfer expanded beads into those molding machines when a molding operation is to be carried out.

Given the tremendous volume taken up by such expanded beads (as compared to the volume of the resins used to ultimately produce those beads), freight costs make it impractical to supply a molding manufacturer with already fully expanded or extruded beads ready for a molding operation, such that in order for the manufacturing process to remain economical, bead expansion must take place on site at the molding facility. Unfortunately, however, this requires a molder to make a significant investment in the equipment necessary to expand the resins, or at least commercially prepared, pre-expanded pellets, into expanded beads. Significant savings could be realized in both equipment costs and freight expenses if the molding facilities could receive the resins as feed stock, and without having to invest in expensive expansion or extrusion equipment, process such resins into the expandable beads needed for molding foam articles. Expandable polystyrene also contains volatile pentane blowing agents, which have to be collected and disintegrated. Thus when expanded polystyrene is molded at sizeable facilities, abatement systems are also generally built.

Accordingly, it is an object of the present invention to provide a device for manufacture, delivery and molding of expanded particles especially compostable or biobased particles that avoids the disadvantages described above.

### BRIEF SUMMARY

A portable extrusion system for the production of expanded particle foam is described including a mobile support surface having an extruder securely attached thereto, the extruder having a front end and a back end connected by a tubular mid-section, an extruder screw contained within the extruder, a motor connected to the extruder screw, a power source connected to the motor, the extruder containing a fluid injection port, a container specifically adapted for containing gas and/or gas-forming fluid in fluid flow communication with the extruder through the injection port, heaters attached to the extruder including at least a portion the mid-section, a foam raw material feed port connected to the mid-section at the front end, and an extrusion die and pelletizer connected to the mid-section at the back end.

Additional embodiments include: the portable extrusion system described above where the mobile support surface is a truck, flatbed, or trailer; the portable extrusion system described above where the power source is an external power source or internal power supply connected to the motor; and the portable extrusion system described above where the extruder screw includes a short compounding twin screw and a longer single extrusion screw in tandem.

A method of producing foam particles using the portable extrusion system described above is also described. Additional embodiments include: the method described above where the gas is CO₂ or supercritical CO₂; the method described above where the foam raw material contains a physical or chemical blowing agent; the method described above where the blowing agent contains nitrogen; and the method described above where the foam raw material includes expandable polylactic acid, expandable polystyrene, expandable polypropylene, expandable polyethylene, expandable polyethylene terephthalate, expandable polyvinyl chloride, expandable thermoplastic polyurethane, and/or mixtures, homopolymers, graft polymers and copolymers thereof.

A method of molding the foamed particles produced above into a finished article is also described. Additional embodiments include: the method described above where the molding is performed with an electric portable particle molding machine; the method described above where heat to the mold is supplied by electrical resistive heating or electrically heated fluids; the method described above where portable bead storage containers and portable pressurization tanks are utilized prior to molding; the method described above where pressure used for conveying and pressurization of the particles is remotely supplied; the method described above where the foamed particles are supplied to remote molding facilities for subsequent molding; the method described above where the foam particles are molded in pre-existing EPS molding machines; and the method described above where the finished article comprises thermal insulators, protective packaging, insulation panels, coolers, or shipping containers.

These and additional embodiments, will be apparent from the following descriptions.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a side elevational view, with parts cut away for clarity, of a mobile extruder in accordance with this invention.

FIG. 2 shows a general process schematic for bead production by extrusion foaming process according to the present invention.

### DETAILED DESCRIPTION

The invention summarized above and defined by the enumerated claims may be better understood by referring to the following description. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

An extrusion process on a mobile platform having an extruder, a PLA hoist/feeder, and related equipment to create pre-expanded foam are described herein. Also described is a method for producing compostable or biobased expandable beads using melt processing techniques on a mobile platform. Likewise, a mobile device for processing raw (unexpanded) PLA is described, including an extruder for melt-mixing raw materials into compostable or biobased expandable beads.

The primary purpose of this device is to produce low density molded parts at a customer's site. A secondary purpose is to supply expanded particles to molders for molding. Additional purposes include to permit the shipment of unexpanded resin, rather than expanded resin, at a very significant freight savings without the need to invest in expansion equipment at the molder's site. In this way, a molder may purchase a small volume of dense resin. A truck or other transport device having a mobile extruder thereon may travel to a molder's manufacturing facility and expand the resin to increase the volume on site (e.g., 40 times) and then drives away. One truck delivering the dense resin can effectively replace 40 trucks of expanded resin. And since there are no VOCs (volatile organic compounds) or emissions, molding and production can happen anywhere. All the process requires is electrical power or a generator.

Thus, a composition and process is provided for producing expandable or extrudable beads from a compostable or biobased thermoplastic polymer using a mobile platform having an extruder and other support equipment, such as a PLA hoist/feeder, and related equipment to create pre-expanded foam. The foamed beads produced by such mobile platform can be further processed using conventional molding equipment to provide a lightweight, compostable or biobased, foamed article. Articles produced from those foamed beads have utility in applications where conventional expandable polystyrene (EPS) is utilized today.

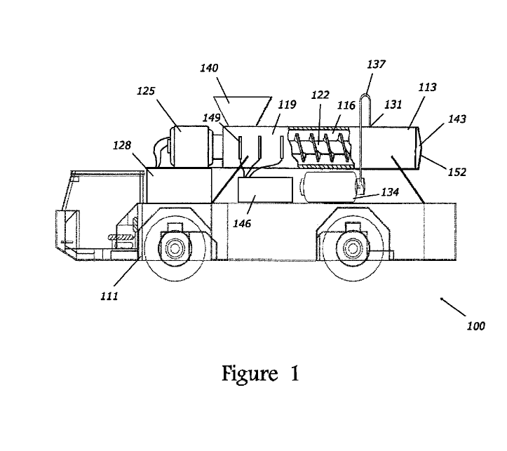

FIG. 1 shows a mobile platform, indicated generally as 100, according to the present invention. The mobile platform 100 includes a flatbed or truck 111 and an extruder 113, The truck 111 may be self-propelled or may be a trailer or the like for transporting the extruder 113 and related equipment. According to the invention, the extruder 113 includes a plurality of stages 116 in a tubular extruder housing 119. An extruder screw 122 is rotatably arranged in the tubular extruder housing 119.

The extruder screw 122 is driven by a motor 125, which may be powered by a power supply 128. In order that the actual mixing process can take place in the various stages of the extrusion housing 119, the screw-shaped displacement element of the extruder screw 122 is in the form of a helical screw flight that extends substantially to the internal surface of the extruder housing 119.

Preferably, the extruder is equipped with an injection port 131 to supply supercritical carbon dioxide (CO₂) into the plastic melt in one of the stages 116. CO₂ in the supercritical state may be provided from a pressurized cylinder 134 or produced by pressurizing liquid CO₂ with a high-pressure pump to an appropriate pressure, such as 27.6 MPa (4000 psi). In a preferred embodiment, all pressurized tubing 137 should be jacketed for cooling with a conventional ethylene glycol—water mixture at a set point of 2° C. (35° F.).

The extruder 113 includes a feed hopper 140 for providing raw materials for mix melting into the beginning stage of the extruder 113. In the extrusion foaming process, the temperature profile of the extruder 113 must be carefully controlled to allow for melting and mixing of the solids, reaction with the chain extension agent, mixing with supercritical CO₂, and cooling of the melt mixture prior to extrusion through a die 143. A controller 146 to monitor and maintain the temperature in the various stages may be provided. The controller 146 should be connected to heaters 149 in each of the stages. The temperatures of the first few stages allows for melting and mixing of the solids, including the dispersion of nucleating agent within the melt. At the same time, the chain extension agent reacts with the chain ends of the polymer, increasing branching and molecular weight, which increases viscosity of the melt and improves the melt strength of the plastic. In some embodiments, prior to injection of CO₂, reversing screw elements and narrow clearance disk elements may be used to produce a melt seal that stops the flow of high pressure CO₂ from exiting the feed throat 131. The melt seal maintains pressure within the extruder 113 allowing the CO₂ to remain soluble within the melted plastic. After CO₂ injection, combing distributive mixing elements may be used to mix CO₂ with the melt, Soluble CO₂ within the plastic plasticizes the melt dramatically, greatly reducing its viscosity. The plasticization effect allows for the cooling of the melt to far below the normal melting temperature of polymer along the last several stages of the extruder 113. The cooling is necessary to increase the viscosity of the plasticized melt, allowing for retention of a closed cell structure during foaming at the die 143. Attached to the die 143 may be a pelletizer to cut the extrudate as it exits the die 143. The extrusion system can also be a tandem system where a conventional shorter twin screw extruder is mounted above a conventional single screw extruder. Thus the process of reacting and cooling can be separated to reduce overall length of the overall system.

The compostable or biobased polymers of this invention are produced by meltprocessing compostable or biobased polymers with a blowing agent and, optionally, additives that modify the rheology of the compostable or biobased polymer, including chain extenders and plasticizers. The compostable or biobased polymers may include those polymers generally recognized by one of ordinary skill in the art to decompose into compounds having lower molecular weights. Non-limiting examples of compostable or biobased polymers suitable for practicing the present invention include, starch, polysaccharides, peptides, polyesters, polyamino acids, polyvinyl alcohol, polyamides, polyalkylene glycols, and copolymers thereof.

In one aspect, the compostable or biobased polymer is a polyester. Non-limiting examples of polyesters include polylactic acids, poly-L-lactic acid (PLLA), poly-D-lactic acid (PDLA) and random or stereoregular copolymers of L-Lactic acid and D-lactic acid, and derivatives thereof. Other non-limiting examples of polyesters include polycaprolactone, polyhydroxybutyric acid, polyhydroxyvalerie acid, polyethylene succinate, polybutylene succinate, polybutylene adipate, polymalic acid, polyglycolic acid, polysuccinate, polyoxalate, polybutylene diglycolate, and polydioxanone, starch and modified starch.

Preferred polymer resins for this invention include known compostable materials derived from biological sources (e.g. compostable biopolymer resins), but synthetic polymers capable of being composted are also acceptable. The biopolymer polylactic acid (PLA) is the most preferred example due to its known compostability and its biobased origins from agricultural (e.g. corn) feedstocks. Both amorphous and semi-crystalline PLA polymers can be used. Examples of compostable or biobased polymers include Ingeo 2002D and Ingeo 4060D grade plastics and Ingeo 8051D grade from Nature Works, LLC, and Cereplast Compostable 5001.

In addition to using conventional PLA polymer materials to make the improved foam beads, other conventional polymer materials can be used as well to produce foam beads as described herein, such as EPS (expandable polystyrene), EPP (expandable polypropylene), EPE (expandable polyethylene), EPET (expandable polyethylene terephthalate), EPVC (expandable polyvinyl chloride), and ETPU (expandable thermoplastic polyurethane), and mixtures, homopolymers, graft polymers and copolymers thereof, for example.

The expandable beads of this invention are produced using a compound comprising a compostable or biobased polyester and a blowing agent. Additives including plasticizers and chain extenders are optionally included in the compostable or biobased composition. Expandable beads can be produced using conventional melt processing techniques, such as single and twin-screw extrusion processes. In one embodiment, melt processing is used to mix compostable or biobased polymer and blowing agent to produce an expandable beads directly from the melt processing operation. In this case, extrudate from the die must be cooled rapidly to lock in the blowing agent so that it does not escape and foaming does not occur. The foamed beads are then molded. If nitrogen is used (as a chemical blowing agent or a physical blowing agent) the wait time before molding can be reduced. Traditional wait times can be 1 to 3 days. The use/addition of nitrogen can reduce wait times to between 2 and 8 hours.

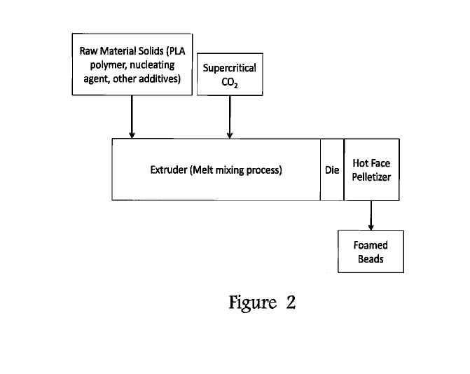

FIG. 2 shows a general process schematic for bead production by an extrusion foaming process. The physical blowing agent, such as supercritical CO₂, is combined with the melt early in the extruder mixing process. Alternatively, it may be necessary to pressurize the bead prior to achieve appropriate expansion in the mold if blowing agents are not used or provide insufficient expansion.

As extrudate exits the die 143 and is foamed, rotating knives of the pelletizer 152 cut the bead at the face of the die 143. When cut, the foam is not completely established. The foaming process continues to shape the structure of the bead after it has been cut. The blowing agent continues to evolve, expanding the particle. The outer skin of the particle remains rubbery while cut, allowing the surface of the foamed bead to flow and reform a smooth, solid surface,

The melt processable, biodegradable foam composition of the invention can be prepared by any of a variety of ways. For example, the biodegradable polymer, physical blowing agent, biodegradable plasticizer, and optional additives can be combined together by any of the blending means usually employed in the plastics industry, such as with a mixing extruder. Preferably, the chemical blowing agent is incorporated into the extrusion process downstream of the injection and mixing of the physical blowing agent. Typically, it is necessary to cool the extrusion mixture before exiting the die in order to maintain adequate melt strength and enable good cell structure of the foam. By adding the chemical blowing agent in the cooler region of the extruder, there is less thermal energy for decomposition of the chemical blowing agent and the resonance time of the material in the extruder is decreased. The materials (biodegradable polymer, blowing agent, biodegradable plasticizer, and optional additives) may be used in the form, for example, of a powder, a pellet, or a granular product. The mixing operation is most conveniently carried out at a temperature above the melting point or softening point of the polymer. The resulting melt-blended mixture can be processed into lightweight strands and subsequently cut into pellets using a strand pelletizer. In another embodiment, foamed pellets are produced by cutting the foamed strand at the face of the extrusion die. The resulting pellets can be molded into a three-dimensional part using conventional equipment utilized in molding expandable polystyrene. Preferably, the foamed pellets contain residual blowing agent and can be post expanded in the molding process.

Melt-processing typically is performed at a temperature from about 80° to 300° C., although optimum operating temperatures are selected depending upon the melting point, melt viscosity, and thermal stability of the composition. Different types of melt processing equipment, such as extruders, may be used to process the melt processable compositions of this invention. Extruders suitable for use with the present invention are described, for example, by Rauwendaal, C., “Polymer Extrusion,” Hansen Publishers, p. 11-33, 2001. Any suitable mobile platform that supports the related equipment can be used.

The amount of components in the melt processable, compostable or biobased composition may vary depending upon the intended end use application. The compostable or biobased polymer may comprise from about 40 to about 99 percent by weight of the final composition.

The melt processable, compostable or biobased composition of the invention can be prepared by any of a variety of ways. For example, the compostable or biobased polymer, hydrophobic additive, hydrocarbon blowing agent, and optional additives can be combined together by any of the blending means usually employed in the plastics industry, such as with a mixing extruder. The mixing operation is most conveniently carried out at a temperature above the melting point or softening point of the polymer. The resulting melt-blended mixture can be processed into lightweight strands and subsequently cut into pellets using a strand pelletizer. The resulting pellets can be molded into a three-dimensional part using conventional equipment utilized in molding expandable polystyrene.

The particle molding process described in copending, commonly assigned provisional U.S. Patent Application Ser. No. 62/084,839, filed on Nov. 26, 2014, the disclosure of which is herein incorporated by reference, uses no cooling water or steam. Thus an all-electric conventional portable particle molding machine can be used for molding. This all-electric portable molding machine is similar to standard EPS machines; however, heat to the mold is supplied by electrical resistive heating or electrically heated fluids. Vacuum is applied by electrical pumps with non-contact fluids. In between the extrusion and molding process, a pop-up bead storage and portable pressurization tanks are utilized. On board (conventional air pressure tanks contained on the portable extrusion platform) or facility supplied air pressure is used for conveying and pressurization. Also, the expanded particles can be supplied to existing molding facilities which can use conventional EPS machines without modification.

As demonstrated herein, portable all-electric molding machines are described enabling distributive manufacturing of particle foam articles such as thermal insulators, protective packaging, and insulation panels. This is possible because of the process described herein. Also, the addition of nitrogen as a physical blowing agent or chemical blowing agent provides additional advantages. The processes and apparatus described herein provide the ability to produce insulated coolers, for example, on site at locations where emergencies (power outage) have occurred—for example, where hurricanes, tornadoes, etc. have occurred to keep food and medicines cold. Low density insulation panels can be produced closer to the use source, reducing, for example, delivered costs of the panels by 20 to 50%.

The invention has been described with references to specific embodiments. While particular values, relationships, materials and steps have been set forth for purposes of describing concepts of the invention, it will be appreciated by persons skilled in the art that numerous variations and/or modifications may be made to the invention as shown in the disclosed embodiments without departing from the spirit or scope of the basic concepts and operating principles of the invention as broadly described. It should be recognized that, in the light of the above teachings, those skilled in the art could modify those specifics without departing from the invention taught herein. Having now fully set forth certain embodiments and modifications of the concept underlying the present invention, various other embodiments as well as potential variations and modifications of the embodiments described herein will obviously occur to those skilled in the art upon becoming familiar with such underlying concept. It is intended to include all such modifications, alternatives and other embodiments insofar as they come within the scope of the invention. It should be understood, therefore, that the invention might be practiced otherwise than as specifically set forth herein. Consequently, the present embodiments are to be considered in all respects as illustrative and not restrictive.

Thus, the scope of the invention shall include all modifications and variations that may fall within the scope of the attached claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A portable extrusion system for the production of expanded particle foam, comprising a mobile support surface having an extruder securely attached thereto, the extruder having a front end and a back end connected by a tubular mid-section, at least one extruder screw contained within the extruder, a motor connected to the extruder screw, a power source connected to the motor, the extruder containing a fluid injection port, a container specifically adapted for containing gas and/or gas-forming fluid in fluid flow communication with the extruder through the injection port, heaters attached to the extruder including at least a portion the mid-section, a foam raw material feed port connected to the mid-section at the front end, and an extrusion die and pelletizer connected to the mid-section at the back end.

2. The portable extrusion system of claim 1, wherein the mobile support surface is a truck, flatbed, or trailer.

3. The portable extrusion system of claim 1, wherein the power source is an external power source or internal power supply connected to the motor.

4. The portable extrusion system of claim 1, wherein the extruder screw comprises a short compounding twin screw and a longer single extrusion screw in tandem.

5. A method of producing foam particles in the portable extrusion system of claim 1, wherein the foam raw material contains a physical or chemical blowing agent, and/or coblowing agent.

6. The method of claim 5, wherein the blowing agent is CO₂ or supercritical CO₂.

7. The method of claim 6, wherein the blowing agent or coblowing agent contains nitrogen.

8. The method of claim 5, wherein the foam raw material includes expandable polylactic acid, expandable polystyrene, expandable polypropylene, expandable polyethylene, expandable polyethylene terephthalate, expandable polyvinyl chloride, expandable thermoplastic polyurethane, and/or mixtures, homopolymers, graft polymers and copolymers thereof.

9. The method of claim 5, including molding the foamed particles formed into a finished article.

10. The method of claim 9, wherein the molding is performed with an electric portable particle molding machine.

11. The method of claim 10, wherein heat to the mold is supplied by electrical resistive heating or electrically heated fluids.

12. The method of claim 9, wherein portable bead storage containers and portable pressurization tanks are utilized prior to molding.

13. The method of claim 9, wherein pressure used for conveying and pressurization of the particles is remotely supplied.

14. The method of claim 9, wherein the foamed particles are supplied to remote molding facilities for subsequent molding.

15. The method of claim 14, wherein the foam particles are molded in pre-existing EPS molding machines.

16. The method of claim 9 wherein the finished article comprises thermal insulators, protective packaging, insulation panels, coolers, or shipping containers.
